(19) United States
(12) Patent Application Publication
(10) Pub. No.: US 2013/0161311 A1
(43) Pub. Date: Jun. 27, 2013

(54) HEATED SENSOR ELEMENT FOR MIXED GAS AND LIQUID ENVIRONMENTS

(71) Applicant: Nelson Burkholder, St. Thomas, PA (US)

(72) Inventor: Nelson Burkholder, St. Thomas, PA (US)

(73) Assignee: MACK TRUCKS, INC., Greensboro, NC (US)

(21) Appl. No.: 13/820,161

(22) PCT Filed: Oct. 12, 2011
(86) PCT No.: PCT/US11/55921

§ 371 Date: Mar. 1, 2013

Related U.S. Application Data
(60) Provisional application No. 61/392,080, filed on Oct. 12, 2010.

(51) Int. Cl. H05B 3/02

(52) U.S. Cl. CPC H05B 3/02
USPC 219/221

(57) ABSTRACT

A heated substrate element for a gas sensor includes a ceramic substrate element having a first surface and a second surface opposite the first surface, a heating element formed on the first surface and, a passive heat conducting metallic layer formed on the second surface. The element is able to resist cracking stresses from sudden local changes in temperature, such as occur when a liquid drop strikes the element.

### BACKGROUND OF THE INVENTION

Some types of high temperature gas sensors include a ceramic substrate element plated with a metal electrical conductor (typically platinum) as a high temperature heat source. These sensors are heated by the electrical conductor to a temperature higher than the temperature of the gas in the conduit, and the heated area of the sensor is exposed to the gas flow. These sensors, including oxygen, NOx, mass flow and specialty sensors, are used, for example, in the intake and exhaust conduits of heavy duty Diesel engines.

In internal combustion engine intake and exhaust conduits, liquids may be unintentionally present in the gas stream. For example, water from condensed humidity may be present during start-up or because of problems with the coolant, engine fuel because of fuel injector problems, engine oil because of engine seal or turbocharger issues, or coolant from cylinder sealing or exhaust gas recirculation cooler issues.

In current Diesel exhaust gas treatment systems, liquids are intentionally injected into the exhaust systems in areas where, as part of the treatment systems, high temperature gas sensors are used. In many cases liquids are injected periodically during regular use of the engine, for example, urea injection for a NOx reducing Selective Catalytic Reduction system, and hydrocarbon fuel for heating Diesel Particulate Filter systems,

A problem can occur with heated ceramic substrate elements if liquid is present in the gas stream. When a drop of liquid contacts the heated element, the ceramic substrate at the contact area is immediately cooled to the temperature of the liquid, and the temperature differential causes a stress in the material. Ceramic material is crystalline and brittle, and the temperature differential can cause the ceramic to crack, which eventually leads to failure of the substrate element and heating conductor.

For example, the heated substrate element may be operational at 700° C. If a drop of water, which is a liquid to 100° C., strikes the element, a localized area of the element is cooled to 100° C. A temperature differential across the boundary of the liquid contact area is about 600° C., creating temperature differential stresses in the ceramic substrate.

Typically, the control system for the heated substrate sensor senses the reduction of temperature and responds by supplying more power to the heater. However, the application of additional power adds to the imbalance of the cool spot to the rest of the heater temperature, which amplifies the differential temperature stress.

A crack in the ceramic substrate can produce strain in the metal electrical heater conductor. The portion of the conductor under strain may experience an increase in the electrical resistance, which can result in a temperature hot spot in the heater conductor, which can cause the metal to melt and the heater circuit to open.

Accordingly, solving the problem of liquid contact heat stress failures in sensors is important.

One approach to solving this problem is software control of the heated sensor. U.S. Pat. No. 7,084,378 discloses an algorithm for control of the heating cycle to prevent sensor body failures. However, software can respond only after the temperature change is detected.

### SUMMARY OF THE INVENTION

The invention is an improvement in sensors that include a ceramic heater substrate plated with a metal (platinum) conductor.

The invention proposes providing, by plating or otherwise, a passive heat conductive layer on the opposite side of the high temperature heater on a ceramic substrate. The heat conductive layer, preferably a metallic material, is a better conductor of thermal energy than ceramic. The heat conducting layer is believed to act as a thermal damper by absorbing and distributing thermal energy, preventing the overly rapid heating of the ceramic substrate that causes fracture of the substrate. By “passive” is meant the metal layer has no electrical connection and no heat source or sink connections other than contact with the ceramic substrate.

The passive metal layer is also believed to lessen the cooling effect of moisture or liquid contacting the sensor substrate by transferring heat over a larger area of the substrate to the liquid contact area.

The passive metal layer is believed to distribute heat longitudinally of the ceramic substrate, which helps prevent site overheating as a failure mode.

According to one embodiment of the invention, the ceramic substrate is formed with a tip on which the heating element is disposed, the tip being a narrower, smaller cross section region, and a base, being a wider, larger cross section region. The plating extends from the tip onto a portion of the base, which facilitates distributing heat energy from a smaller mass area to a larger mass area of the substrate.

The metal layer is also believed to act to mechanically reinforce the ceramic substrate, maintaining integrity and minimizing the flexure of the substrate.

The passive metal coating may be formed with a curved or wavy end edge line on the base end to increase the effective heating distance in the lateral direction of the substrate.

The invention may also be embodied in a cylindrical substrate. According to one embodiment, the cylindrical substrate is a solid cylinder of ceramic material with a heating element provided on the surface at an end portion and a passive metal coating provided on an opposite side of the same end portion.

According to another embodiment, a sensor substrate is formed as a hollow cylinder with a heating element formed or deposited on an outer surface at an end portion and a passive metal coating provided on an interior surface opposite the heating element location. Alternatively the passive metal coating may comprise a metal core in the hollow cylinder.

### BRIEF DESCRIPTION OF THE DRAWINGS

The invention will be better understood by reference to the following Detailed Description read in conjunction with the appended drawings, in which:

FIG. 1 shows a plan view of a sensor substrate element with a heating element applied to a first surface;

FIG. 2 shows a plan view of an opposite side of the sensor substrate element of FIG. 1, illustrating a passive metal plating according to an embodiment of the invention;

FIG. 3 shows a cross sectional view of a cylindrical sensor substrate element according to an alternative embodiment; and,

FIG. 4 shows a cross sectional view of a second embodiment of a cylindrical sensor substrate element.

### DETAILED DESCRIPTION

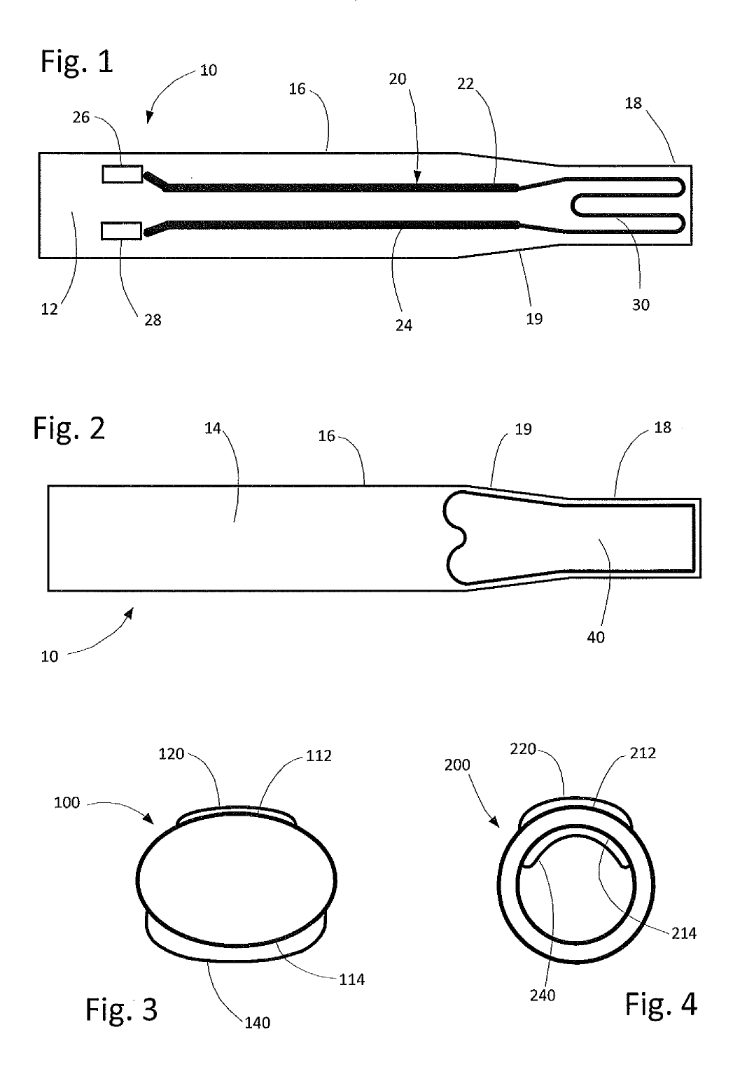

A heated substrate element for a gas sensor according to a first embodiment of the invention is shown in FIGS. 1 and 2. A ceramic substrate element 10 may be, as shown, a plate of a ceramic material, such as alumina. The substrate element 10 has a first surface 12 and a second surface 14 opposite the first surface. The element 10 of the illustrated embodiment has a first end portion or base 16 and a second end portion or tip 18. The base 16 is wider than the tip 18, and the base includes a tapered region 19 to transition the width of the base to the width of the tip. The substrate element 10 may take other shapes that provide a heated portion that may be positioned in a gas flow.

A heater 20 is formed on the first surface. The heater 20 may be a resistive film element, such as a platinum layer disposed on the first surface 12 by any convenient means such as deposition and etching or printing, for example. The heater 20 includes leads 22, 24 having terminals 26, 28, respectively, for connecting to a power source. The heater 20 includes a heating element 30, shown as a serpentine portion, formed at the tip 18.

The tip 18 and heating coil 30 are exposed to the gas when the heated substrate element 10 is in use.

A heat conducting layer 40 is formed on the second surface 14 at the tip 18. The heat conducting layer 40 is opposite the heating element 30, meaning it is located a shortest distance through the element from the heating element. The heat conducting layer 40 is formed of a material having high heat transfer properties, preferably a metal. The heating conducting layer 40 extends on the second surface 14 to cover at least the tip 18 and a portion of the base 16.

As known in the art, ceramic is a low heat conducting material and a ceramic substrate provides a thermal mass that can maintain a steady temperature. The heat conducting layer 40 of the invention provides a relatively high heat transfer layer that can quickly distribute heat across the ceramic substrate in the contact area. The heat conducting layer 40 is passive, that is, it is not connected to an external heat source or heat sink.

According to the invention, the heat conducting layer 40 extends onto the base 16 of the substrate element 10 to provide heat conduction between the tip 18 and the base. An edge of the heat conducting layer 40 at the base 16 is non-linear, that is, is formed as a wavy or curved line to provide an extended distance across the base.

In testing, a heated ceramic substrate sensor according to the invention experienced a 444% improvement in sensor service life when compared to a substrate without a heat conducting layer.

According to an alternative embodiment illustrated in FIG. 3, a heated ceramic substrate element according to the invention may also be formed as cylindrical body 100. FIG. 3 shows a substrate element having an elliptical cross section. The substrate element may take a circular cross section. The substrate element 100 has a heater 120 formed on a first surface 112 and a heat conducting layer 140 on the opposite side 114.

An additional alternative embodiment is shown in FIG. 4 in which the substrate element 200 has a hollow cylindrical body. According to this embodiment, a heater 220 is provided on an outer surface 212 of the element 200 and a heat conducting layer 240 is provided on an inner surface 214 of the element opposite the heater. The heat conducting layer may alternatively be formed as a metallic core.

The embodiments of FIGS. 3 and 4 may include other aspects described in connection with FIGS. 1 and 2, including the substrate element have a narrow tip portion with the heater formed the first surface at the tip.

The invention is described in terms of illustrative embodiments and components, however, those skilled in the art will recognize that substitutions may be made without departing from the scope of the invention as defined by the appended claims.

What is claimed is:

1. A heated substrate element for a gas sensor, comprising:
a ceramic substrate element having a first surface and a second surface opposite the first surface;
a heating element formed on the first surface; and, a passive heat conducting layer formed on the second surface.

2. The heated substrate element of claim 1, wherein the ceramic substrate element is formed as a plate.

3. The heated substrate element of claim 1, wherein the ceramic substrate element has a tip extending from a base, the tip being narrower than the base, and a transition portion between the tip and the base, wherein the heating element is formed on the first surface at the tip and wherein the heat conducting layer is formed on the second surface at the tip.

4. The heated substrate element of claim 3, wherein the heat conducting layer is formed on the second surface at the tip, the transition portion, and part of the base.

5. The heated substrate element of claim 1, wherein the heating element is a thin film resistive heating element.

6. The heated substrate element of claim 1, wherein the heat conducting layer is formed of a metal.

7. The heated substrate element of claim 1, wherein the heat conducting layer extends longitudinally along the second surface at least as much as the heating element extends longitudinally along the first surface.

8. The heated substrate element of claim 1, wherein the heat conducting layer extends from a first end portion to a second end portion, and wherein an edge of the heat conducting layer at the second end portion is non-linear.

9. The heated substrate of claim 1, wherein the ceramic substrate element is formed as a cylinder, and wherein the first surface and second surface are circumferentially opposite.

10. The heated substrate of claim 1, wherein the ceramic substrate element is formed as a hollow cylinder and wherein the first surface is an outer surface of the hollow cylinder and the second surface is an inner surface of the hollow cylinder.

11. The heated substrate of claim 10, wherein the passive heat conducting layer comprises a core of metallic material in the hollow cylinder.
